(19) United States
(12) Patent Application Publication
(10) Pub. No.: US 2024/0316547 A1
(43) Pub. Date: Sep. 26, 2024

(54) THERMALLY DRAWN SENSOR DEVICE AND A METHOD OF FABRICATION THEREOF

(71) Applicant: ECOLE POLYTECHNIQUE FEDERALE DE LAUSANNE (EPFL), Lausanne (CH)

(72) Inventors: Fabien SORIN, St-Sulpic (CH); Bastien SCHYRR, Neuchâtel (CH)

(73) Assignee: ECOLE POLYTECHNIQUE FEDERALE DE LAUSANNE (EPFL), Lausanne (CH)

(21) Appl. No.: 18/273,542

(22) PCT Filed: Jan. 20, 2021
(86) PCT No.: PCT/IB2021/050411

§ 371 Date: Jul. 20, 2023

(51) Int. Cl. B01L 3/00; D01F 1/10; D01F 8/00

(52) U.S. Cl. CPC B01L 3/502707; D01F 1/10; D01F 8/00; B01L 2200/12; B01L 2300/0838; B01L 2300/0845; B01L 2300/12; B01L 2400/0406; D10B 2401/022; D10B 2509/00

(57) ABSTRACT

One aspect of the present invention relates to a method of fabricating a chemically active fibre device (1) by thermal drawing. The method comprises the steps of providing a preform, the preform comprising a support element (3) at least partially made of a first polymeric material; and carrying out a thermal drawing process of the preform to produce a thermally drawn fibre. The preform comprises one or more chemically active agents and/or biological materials configured to react with a fluid sample when the one or more chemically active agents and/or biological materials are in contact with the fluid sample. In this manner miniaturised lab-in-fibre devices can be fabricated.

### TECHNICAL FIELD

The present invention relates to a chemically active fibre device representing a new type of miniaturised platform for multianalyte testing. The proposed device may be used for instance for point-of-care testing. The present invention also relates to a corresponding fabricating method of the chemically active fibre device.

### BACKGROUND OF THE INVENTION

Point-of-care testing (POCT) devices for rapid on-site diagnosis are a key component of personalised healthcare when costs, equipment, or time limitations preclude the use of conventional laboratory analysis. Lab-on-chip systems have been extensively researched to achieve fully automated and multiplexed analysis, but they still fail to be competitive in terms of price and simplicity. In the opposite direction, low-cost paper-based devices with minimal sample processing functionalities have found wide adoption thanks to their ease of fabrication and use. Best known examples involve lateral flow assays (e.g., pregnancy tests), and urine test strips. More recently, microfluidic paper-based analytical devices (μPAD) have opened new opportunities for more sophisticated microfluidics and multiplexing. Nonetheless, these devices often suffer from insufficient limit-of-detection or only provide semi-quantitative information. In addition, many applications require a sensor probe able to perform measurements at precise locations that can be hard to reach with planar devices.

In the context of wound management, diagnosis methodologies predominantly rely on the visual evaluation of signs and symptoms (size, colour, odour, tissue aspect, etc.). Their relative subjectivity, combined with the variability between patients and the inherent complexity of the healing process, make wound assessment extremely challenging. Analytical laboratory techniques, such as microbiological assays are in general too cumbersome for their routine use in wound assessment and are thus limited to cases with high risk of complications. At the moment, there are no satisfactory tools available for bedside evaluation of wound healing. In consequence, chronic wounds such as venous and diabetic foot ulcers are characterised by elevated management costs and poor treatment outcomes. New diagnostic tools to provide rapid analysis of the wound fluid at the patient bedside and tools to assist treatment decisions are thus urgently needed to improve the cost-efficiency of modern wound care.

Centred around the needs for rapid assay time, scalable fabrication, and handiness, new approaches are being developed to attain single-step microfluidic bioassays. Capillary format analytical systems have attracted renewed interest as simple, low-cost platforms. A characteristic feature is the use of microchannels that allows infiltration of microlitre-sized samples by capillarity. Capillary action for sample loading simplifies the design of microfluidic device, as opposed to methods based on syringe, electrokinetics or centrifugal force, and is now used in a variety of lab-on-chip diagnostic devices. The intrinsic properties of capillaries for simultaneous light and liquid manipulation (optofluidic) make them an ideal platform to perform optical assays in remote locations. Hence, they have been used for fluorescent immunoassays, enzyme-linked immunosorbent assays (ELISA), colorimetric bacteria viability tests, and even polymerase chain reaction (PCR). However, one major hurdle remains in the integration of chemical functionality to reproduce the broad range of bioassay currently exploited in the lab. Most approaches rely on the post-modification of glass or polymer capillaries with a “reaction cocktail” containing the different assay reagents using copolymerisation in a hydrogel network, dissolvable coatings, or layer-by-layer deposition. Despite enabling mild immobilisation condition, each channel needs to be functionalised individually, which limits the scalability of this fabrication method. Multi-layered architectures for heterogeneous assays have also been demonstrated, but they involve a cumbersome fabrication process or a two-component capillary assembly.

Thermal drawing is a powerful technique for the production of microstructured fibres and capillaries, which could alleviate many of the aforementioned limitations. The process starts from a macroscopic preform that is heated above its glass transition temperature and drawn, effectively scaling down all the constituents into a fibre geometry that maintains the original preform architecture. It is simple, low cost, and yields extended lengths of highly uniform fibres with well-controlled structures. Furthermore, it can accommodate a large variety of materials, including polymers, metals, and semiconductors. Hence, it can create new functionalities by enabling the fabrication, integration and physical connection between several structures and materials at the nano- and micro scale. To date, fibres with photosensitive, electronic, thermomechanical and acoustic properties have thus been created.

### SUMMARY OF THE INVENTION

It is an object of the present invention to overcome at least some of the problems identified above related to POCT devices and their fabrication.

According to a first aspect of the invention, there is provided a method of fabricating a chemically active fibre device as recited in claim 1.

The exploited thermal drawing process has the advantage of being a scalable method of producing ready-to-use POCT devices, which optionally are multi-capillary fibres. The sensing chemistry is incorporated at the preform stage for example in the form of plasticised films of (bio)polymers and/or sugars, which provide a stabilising matrix for labile biological molecules with reciprocal thermomechanical compatibility with the support element material during thermal drawing. A high viscosity polymeric material suitable for thermal drawing may be used as the support element. The drawing process is advantageously carried out at relatively low temperature compared to classical thermal drawing approaches in order to maximise the stability of the active agents of the device during the thermal drawing process. Advantageously, a material with low melting point between 40° C. and 50° C. (as measured by differential scanning calorimetry (DSC)) can be used as the support element material to minimise the processing temperature, such as poly(ethylene vinyl acetate) (EVA) grades with high vinyl acetate content (40% by weight). Thermal drawing then results in capillaries or channels (if capillaries are desired in the device) already loaded with active agents in a single fabrication step without any post-modification. The active agents and/or biological materials in the device thus remain chemically active after the thermal drawing process. After the thermal drawing process, the drawn fibre may then be chopped into a few centimetre-long pieces, effectively obtaining hundreds/thousands of ready-to-use chemically active fibre devices forming individual test tubes. Analyte quantification or detection may rely on simple image analysis of light transmission through the lab-in-fibre device and/or on one or more other optical, electrical or optoelectronic methods such as fluorescence and chemiluminescence.

According to a second aspect of the invention, there is provided a chemically active fibre device as recited in claim 26.

The proposed chemically active fibre device is ready to be used as POCT device. More specifically, no post-modification of the device with a “reaction cocktail” is needed. The device has further the advantage of having a very small size and thus forming a fibre device, and it is optionally disposable. One or more channels may be provided within the device to allow liquid to flow in the channels thanks to the capillary effect. The proposed device may for instance be used for wound exudate analysis, and it may implement a plurality of assays, such as a pH indicator, a cascade enzymatic assay for glucose or lactate, an immunoassay for C-reactive protein (CRP), and a proteolytic activity test. These parameters are established indicators of the healing status of a wound and early infections. The capacity of delivering such pieces of information during a consultation is expected to greatly support evidence-based medicine in chronic wound management. The proposed device may also be used in other fields of applications, such as testing saliva, sweat or blood.

Other aspects of the invention are recited in the dependent claims attached hereto.

### BRIEF DESCRIPTION OF THE DRAWINGS

Other features and advantages of the invention will become apparent from the following description of non-limiting example embodiments, with reference to the appended drawings, in which:

FIG. 1 is an isometric view of the chemically active fibre device according to a first example embodiment of the present invention;

FIG. 2 is a cross-sectional view of the chemically active fibre device shown in FIG. 1, where the cross section is taken orthogonally to a longitudinal axis of the chemically active fibre device;

FIG. 3 illustrates how the chemically active fibre device can be used for C-reactive protein (CRP) sensing;

FIG. 4 is a flow chart illustrating the thermal drawing process;

FIG. 5 a schematic view illustrating the thermal drawing process;

FIG. 6 is an isometric view of the chemically active fibre device according to a second embodiment of the present invention;

FIG. 7 is a cross-sectional view of the chemically active fibre device of FIG. 6;

FIG. 8 is an isometric view of the chemically active fibre device according to a third embodiment of the present invention;

FIG. 9 is a cross-sectional view of the chemically active fibre device of FIG. 8;

FIG. 10 is an isometric view of the chemically active fibre device according to a fourth embodiment of the present invention;

FIG. 11 is a cross-sectional view of the chemically active fibre device of FIG. 10;

FIG. 12 is an isometric view of the chemically active fibre device according to a fifth embodiment of the present invention; and

FIG. 13 is a cross-sectional view of the chemically active fibre device of FIG. 12.

### DETAILED DESCRIPTION OF EMBODIMENTS OF THE INVENTION

Some embodiments of the present invention will now be described in detail with reference to the attached figures. The different embodiments are described in the context of a lab-in-fibre device for wound exudate analysis, but the teachings of the invention are not limited to this environment. Identical or corresponding functional and structural elements which appear in the different drawings are assigned the same reference numerals. The drawings are not necessarily drawn to scale. As utilised herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” Furthermore, the term “comprise” is used herein as an open-ended term. This means that the object encompasses all the elements listed, but may also include additional, unnamed elements. Thus, the word “comprise” is interpreted by the broader meaning “include”, “contain” or “comprehend”.

In the present description, a fibre may be defined to be an object that is significantly longer than it is wide, in other words, the object has a high aspect ratio. The aspect ratio may thus be at least 5, 100, or 1000, which is thus the length of the object divided by its greatest cross-sectional dimension, the cross section being measured substantially orthogonally to the longitudinal axis of the object.

The present invention proposes a single or multi-material fibre-shaped or fibre-like apparatus or device, which is also simply referred to as a fibre, whose cross section (taken substantially orthogonally to the longitudinal axis “A” of the device) can be microstructured with several materials and shaped to be deployed in a variety of configurations. The fluid to be sensed can flow inside one or more microchannels embedded in the fibre, or around the fibre. The microchannels have a cross-sectional diameter between 50 μm and 5 mm or more specifically between 50 μm and 500 μm. If the fibre has only one channel, then the cross section of the entire fibre may be between 10% and 500%, or more specifically between 20% and 200% greater than the cross section of the channel. The fibre devices can have various shapes: an elongated device with circular, oval or rectangular cross section, a device with a hollow core, a substantially U-shaped device, etc. Sensing can occur along the entire length of the device or along a portion of it. Its cladding, which may be polymer cladding, can encapsulate other functionalities, such as thermal and strain sensing, forming multifunctional elongated flow sensors. Fabricated by thermal drawing, the devices benefit from the costs traditionally associated with conventional optical fibre production. Such costs allow the device to be used as “disposable”, meaning it can be embedded within a part or used for contaminated samples. It is further to be noted that the thermally drawn fibre can be cut into a large number of small devices to be integrated in smaller systems, again benefiting from the scalability of the fabrication technique.

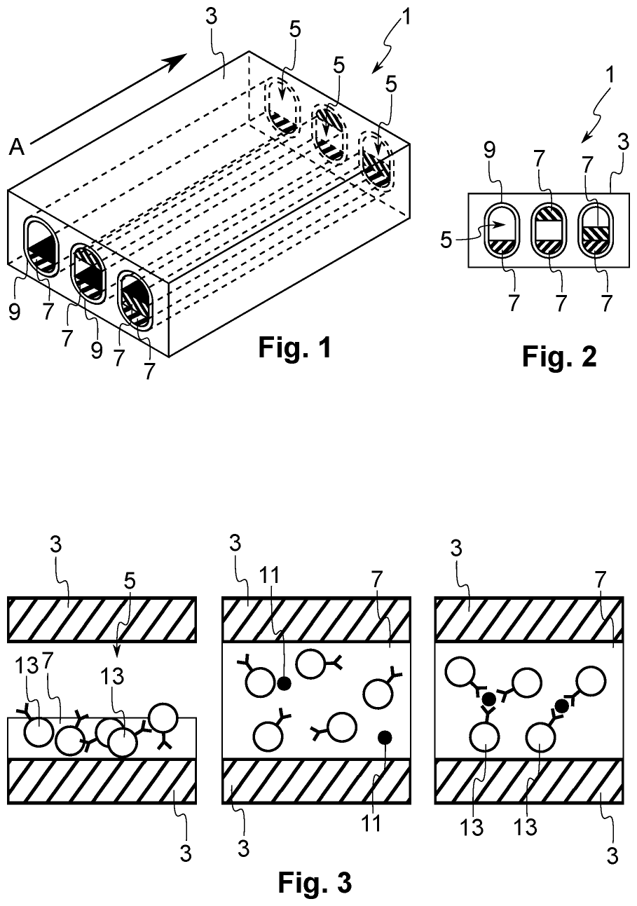

The proposed chemically active fibre device or sensor device 1 or test probe according to the first example embodiment is next explained in detail with reference to FIGS. 1 and 2. The fabrication process of the device, which uses thermal drawing, is explained in more detail later. As can be seen in the figures, the device comprises an elongated support element 3, substrate or simply support, which is a fibre-like element. According to this embodiment, one or more capillaries or channels 5 (support element channels or first channels) are provided within the support element such that they, in this example, extend longitudinally between a first end of the support element and a second, opposite end of the support element 3. In the present description, a capillary may be understood to be an elongated channel having the cross-sectional dimension, which may be constant or non-constant, and which is measured orthogonally to a capillary longitudinal axis, in the range of 1 μm to 1000 μm, or more specifically in the range of 5 μm to 500 μm. As shown in the figures, the channels extend parallel or substantially parallel to a longitudinal or central axis “A” of the support element. In this example three channels are provided, although any desired number of channels would be possible instead. As the support element encompasses or surrounds the channels, the support element may also be referred to as a cladding 3. The support element is made or partially made of a first material, which in this example is a first polymeric material. The entire support element or at least a part of it may be transparent or translucent allowing light to pass though the material. The advantage of using a transparent or translucent material is that a user or technician may inspect the chemical reaction taking place within the channel(s) through the support element 3. The first polymeric material may have a density comprised between 0.85 g/cm³ and 1.4 g/cm³. The first material may be selected from a non-limiting list comprising ethylene vinyl acetate, polyvinyl chloride, one or more ionomers, polycaprolactone (PCL), glycol-modified polyethylene terephthalate (PETG), poly(lactic-co-glycolic acid) (PLGA), one or more polyolefin elastomers, amorphous poly(lactic acid) (amorphous PLA), and gelatin.

The device 1 as shown in FIGS. 1 and 2 further comprises an active agent carrier 7, which comprises or embeds one or more chemically active agents, which may be different types of chemically active reagents, transducers or bioreceptors, and/or one or more biological elements/materials or biologically derived materials, such as cells, enzymes, antibodies, nucleic acid, etc. Furthermore, in the present description, the term “chemically active agents” also covers biochemically active agents. The agent carrier is understood to be a substance supporting and/or at least partially embedding the active agents. The agent carrier 7 is made or partially made of a second material, which may be a second polymeric material, which may not be the same polymer as the first polymer. The second polymeric material may for instance be a polysaccharide, such as agarose, or a polypeptide, such as gelatin. However, the second material could instead be a saccharide, such as trehalose or sucrose. The second material may be dissolvable in the liquid sample when the second material gets in contact with the liquid sample. Instead or in addition, the second material may be porous, such that the pores may have the greatest dimension between 2 nm and 500 nm. Porous materials in general are classified either as “open” or “closed” foams. In the terminology of foam science, closed foams have “cells” (pores, voids) where the faces shared with neighbouring “cells” are solid membranes. These closed foams entrap the pore fluid, which cannot easily escape through the solid membranes delimiting the “cells”. Classical open foams, for example typically formed by agarose and gelatin, have no membranes between neighbouring cells, but only struts along the edges where three or more cells meet. Such open foams naturally have a fully interconnected pore space, and a fibrous network of solid material. The porosity has the advantage of increasing the reactive surface area and thus the chemical reaction may be accelerated or facilitated in this manner. The second material may more specifically be a gel or a gel-like material, a dehydrated material or a partially dehydrated material, where the gel-like material may be a polymerised gel, a physical hydrogel or a soluble element, such as an excipient, for instance in the form of a coating. The gel-like material may be selected from a non-limiting list comprising chitosan, alginate, agarose, gelatin, elastin, collagen, agar/agarose, chitosan, fibrin, proteoglycans, a polyamino-acid or its derivatives, preferably polylysin or gelatin methyl cellulose, carbomethyl cellulose, polysaccharides and their derivatives, preferably glycosaminoglycanes, such as hyaluronic acid, chondroitinsulfate, dermatansulfate, heparansulfate, heparine, keratansulfate, polylipides, fatty acids, starch, poly(ethylene glycol), polymerisable hydrogels, such as acrylamide, as well as any derivative thereof, a fragment or fragments thereof, and any combination thereof. The carrier 7 may be arranged within the support element 3 as a coating around the channels 5, or in addition or alternatively, as a thick or thin layer within the respective channel, or it may occupy the entire or substantially the entire cross section of the respective channel, for instance as a porous material. It is to be noted that any given channel may comprise merely one type of carrier 7, or it may comprise two or more carriers, optionally of different types, i.e., of different materials.

As is explained in more detail later, the agent carrier 7 may comprise one or more plasticisers and/or excipients to change the properties of the agent carrier. A “plasticiser” is a substance that is added to a material to make it softer and more flexible, to increase its plasticity, to decrease its viscosity, or to decrease friction during its handling in manufacture. Excipients are defined as non-active substances formulated alongside the chemically or biologically active ingredients to aid in the manufacturing process, for instance by acting as a carrier for the active substances, by reducing viscosity or increasing solubility, or to support or enhance stability against heat, dehydration or during storage. The plasticisers, which can be considered to fall into the category of excipients, and excipients more broadly in the framework of the present invention may be selected from a non-limiting list comprising a mono- di- and/or oligosaccharide, polyols, including glycerol, sorbitol, glucose, sucrose, maltitol, xylitol, erythritol, or isomalt, trehalose, cyclodextrin, maltose, lactose, sorbitol, dimethyl sulfoxide, propylene glycol, ethylene glycol, and polyethylene glycol. In addition, the agent carrier 7 may comprise a buffering system in the form of a weak base and its conjugated acid, or a weak acid and its conjugated base.

The active agents are configured to chemically react with analytes comprised in the liquid sample (not shown in the drawings) received in the channels 5, or with substances generated from such chemical reactions. In some embodiments, the active agents may be “bioactive agents” or “bioactive molecules”, that is, any agent that is biologically active, i.e. having an effect upon a living organism, tissue, or cell. The expression is used herein to refer to a compound or entity that alters, inhibits, activates, or otherwise affects biological or biochemical events. Bioactive compounds according to the present disclosure can be small molecules or macromolecules, including recombinant ones. Active agents according to the present disclosure may be selected from a non-limiting list comprising a growth factor, a protein, a peptide, an enzyme, an antibody or any derivative thereof (such as multivalent antibodies, multispecific antibodies, scFvs, bivalent or trivalent scFvs, triabodies, minibodies, nanobodies, diabodies, etc.), an antigen, any type of nucleic acid, such as deoxyribonucleic acid, ribonucleic acid, small interfering ribonucleic acid, or micro(ribonucleic acid), a hormone, an anti-inflammatory agent, an anti-viral agent, an anti-bacterial agent, a cytokine, a transmembrane receptor, a protein receptor, a serum protein, an adhesion molecule, a lipid molecule, a neurotransmitter, a morphogenetic protein, a differentiation factor, an analgesic, pharmacologically active organic molecules including drugs, such as antibiotics or chemotherapeutics, pH indicator organic molecules, a cell matrix protein, a vitamin, a pesticide, a spore, a cell, a microorganism including bacteria, fungi and viruses, and any functional fragment or derivative of the foregoing, as well as any combinations thereof. The reaction of the active agents with the liquid to be sampled or sensed may be detected with different transduction mechanisms, preferentially producing an optical signal based on colorimetry, fluorescence, chemiluminescence, or changes in light transmission or light scattering properties. Thus, the device 1 may provide an optical readout for example so that the channels 5 can be observed to change their colour as soon as the chemical or biochemical reaction takes place in the channels. The optical signal may thus directly depend on the concentration and/or the presence of the analytes to be sensed. In other words, the optical signal may thus be proportional to the amount of analyte-active agent interactions.

Beside the support material and agent carriers, one or more additional materials compatible with the thermal drawing process may constitute the preform to provide other functionalities or properties to the drawn fibre. Electrically active materials such as conductive polymers, metals, metallic glasses, and liquid metals can be used as electrochemical transducers in contact with the agent carrier, while semiconductors like selenium can provide optoelectronic functionality for integrated optical detection. Furthermore, elastomers can be used in addition to or as a replacement of support materials where high deformability and softness are desirable, for instance in invasive applications such as catheter or as implantable device, or as mechanical deformation sensors in combination with electroactive materials. Finally, fibre-like materials such as polymeric/silica optical fibres, electric wires and tendons can be intactly integrated along the entire drawn fibre length using e.g. a wire feeding system through the preform material, providing improved optical, electrical or steering (of the active agents for instance) capabilities.

The liquid is received in the channels by a capillary effect, and thanks to this effect, it traverses the channels from a first channel end to a second, opposite channel end. To improve the capillary effect, hydrophilic coating, film or layer 9 is optionally provided on the respective channel surface to completely or partially encompass or surround the respective channel. The hydrophilic film does not dissolve when in contact with the liquid sample, and its aim is to improve the capillary effect. The one or more hydrophilic layers 9 may be at least partially made of a material selected from a non-limiting list selected from poly(ethylene glycol), polyvinyl acetate, poly(vinyl alcohol) and polycaprolactone.

In the present example, the support element 3 is made of EVA, which is particularly suitable for thermal drawing process according to the present disclosure. At high vinyl acetate content (greater than 40%), EVA behaves as an elastomeric rubber-like polymer with glass transition near room temperature. The material is also characterised by low-temperature toughness, stress crack resistance, and resistance to ultraviolet (UV) radiation, which make EVA fibres easy to handle. The selected grade possesses good optical transparency, a low melting point temperature (approximately 47° C.) and fulfils the requirement on viscosity for thermal drawing according to the present disclosure. Starting from a macroscopic preform, multi-microchannels, e.g. several parallel or non-parallel channels, can successfully be drawn into tens of metres of capillaries with an inner diameter as low as 100 μm or even less. The processing temperature for thermal drawing is advantageously minimised down to 60° C., which is key to limit the thermal degradation of fragile/labile assay reagents. EVA exhibits a moderate hydrophilic behaviour, characterised by a static contact angle of approximately 100°. In order to improve the strength of the capillary action, in the present example, a polyvinyl acetate layer is placed on the channel surface at the preform stage, restoring a more hydrophilic surface (static contact angle of approximately 83°) and spontaneous filling of 50 μm to 500 μm diameter channels over a few centimetres. In this specific example, the diameter of the channels is 100 μm to 300 μm. Optionally, the surface hydrophilicity can be further improved by applying a partial hydrolysis treatment to EVA or to the polyvinyl acetate layer, generating poly(ethylene-co-vinyl alcohol) or polyvinyl alcohol, respectively.

The properties and the possible materials of the carrier 7 are next explained in more detail according to the present example. Natural polymers, such as chitosan, alginate, agarose, and gelatin have been extensively researched for their versatile properties, such as biocompatibility, biodegradability, flexibility and ease of modification. In this context, it has been shown that plasticised films of gelatin or casein can be thermally drawn with a great versatility in geometries and mechanical properties (for the encapsulation and release of nutrient). The film thermomechanical properties could be tuned to satisfy the rheological requirements for thermal drawing, i.e., reaching a crossover in moduli between storage and loss modulus. Agarose shares similarities with gelatin as it undergoes a thermo-reversible transition from random coil to helical fibres responsible of its gelling behaviour. Agarose, which is a polysaccharide, forms neutral, non-toxic, macroreticular gels with a high thermal hysteresis and mesh size of several tens of nanometres. These properties make it ideal as sieve for separation techniques such as electrophoresis and chromatography, or as an easily derivatised and inert support material for proteins such as enzymes and antibodies. It has been widely used as a matrix for biocatalysis, with a high enzyme loading capacity, while allowing movement of coenzymes and substrate inside the gel. Reports have also shown that entrapment onto agarose beads can provide better enzyme catalytic performance, shelf-life and stability against temperature up to 70° C.

In agarose gels, glycerol as a plasticiser has been shown to decrease the amounts of free water available for the structural ordering of molecular chains. Consequently, plasticised agarose gels are composed of smaller but more numerous junction zones (helices bundles/aggregates), which produce a more extensive gel network with a higher elastic modulus and a lower melting point. Combined with the use of low melting temperature agarose grade, this effect allows for processing by thermal drawing at low temperatures. After casting and gelation, the gels are advantageously dried in air to obtain a biopolymer film with reciprocal thermomechanical compatibility with the material of the support element during thermal drawing. Drying induces a dramatic shrinkage of the gel network into a compact and continuous structure with little porosity.

In the following, the properties of pH sensitive fibres according to the present disclosure are explained in more detail. Agarose is highly suited for the preparation of porous sensing layers inside the channels 5, offering mild conditions for the physical encapsulation of the active agents and the convenience of gel casting directly inside the channels of moulded EVA preforms. As a straightforward implementation, pH-sensitive fibre channels can be fabricated by incorporating a colorimetric pH indicator in the agarose matrix. The capacity to perform localised pH measurement in minute volume of liquid is of interest in a variety of fields, including food quality/processing testing or health diagnosis in biological fluids such as saliva or urine. In the context of wound assessment, pH monitoring would provide valuable information about the healing stage as well as the inflammatory status, varying in the range between pH 6 to 8 during a couple of days. In addition, an alkalisation of the wound milieu is an indicator of potential bacterial contamination.

In this specific example, phenol red is used as a pH indicator, i.e., as an active agent, which is widely used in cell cultures with best sensitivity in the near-neutral pH range typical of physiological conditions. In solution, the dye transitions from a yellow compound at pH 6 to a pink-red coloration at pH 8.0. A similar behaviour can be observed in thermally drawn pH-sensitive channels. Following rapid filling by capillary action, a homogeneous coloration of the channel 5 is visible after a few seconds, which highlights the rapid diffusion of phenol red molecules out of the agarose matrix. Qualitatively, the pH-sensitive fibre provides a direct visual assessment of pH in the range between pH 6 to 8. However, similarly to cellulose-based pH test strips, naked-eye evaluation provides limited accuracy, especially in the case of biological fluids where variations as small as 0.2 pH units can carry significant information on the underlying biochemical status. A robust approach for the colorimetric image readout relies on hue referencing within the hue, saturation, and value (HSV) colour space. In the present context of a bitonal optical sensor, the hue colour coordinate provides a quantitative signal that is independent of variations in colour intensity coming from inhomogeneities in sensing layer concentration/thickness. The relation between the hue parameter extracted from channel images and the pH of the sampled solution provides a calibration curve with an apparent pKa of approximately 7 for the phenol red indicator.

In the following, the effect of trehalose as an exemplary additive for improved biomolecule stability is explained. Many advanced assays rely on the use of bioreceptors as active agents, such as enzymes and antibodies for specific analyte recognition. Incorporating these molecules in the functional channels 5 would greatly expand the catalogue of achievable tests but faces the challenge of harsh processing conditions during film drying and thermal drawing. Polymer matrices can contribute to the stability of encapsulated material thanks to their good glass forming capability, which reduces protein motions responsible for degradation. However, they generally do not provide a direct stabilising interaction with biomolecules. Preliminary experiments with the enzyme horseradish peroxidase (HRP) contained in plasticised agarose films showed approximately 50% remaining activity after heat treatment at 60° C. for 30 min, and 10% remaining activity after 15 min at 80° C. Further dehydration in vacuum would have an even greater impact on stability, leading to complete deactivation of less robust enzyme, such as glucose oxidase.

To solve this problem, polymers are often used in combination with low molecular weight molecules, such as sugars to improve the matrix stabilising effect. The effect of sugars supposedly relies on vitrification in an amorphous phase and the sugar's capacity to form multiple hydrogen bonds that modulate water concentration in the vicinity of the biostructure and preserve protein's tertiary structures (water replacement theory). When mixed, polymer-sugar mixtures have been shown to contribute synergistically to bioprotection, the high molecular weight polymer providing a high glass-transition temperature Tg, crowding and film-forming properties, while the low molecular weight sugar acts as a direct stabiliser for proteins. Enzyme formulation has thus been reported using mixtures of dextran, hydrophobic polyethylene glycol (PEG), or proteins (bovine serum albumin (BSA), gelatin) and sucrose, or gelatin-trehalose matrices to improve the thermal stability of myoglobin at very low hydration. Trehalose, a non-reducing disaccharide, has been shown particularly efficient in protecting proteins and cells against heat, dehydration and freezing. It has been employed in air-dried preparations of fragile enzymes, showing no loss activity even after extended storage, and the capacity to withstand prolonged exposure to temperature as high as 70° C. Trehalose's bioprotectant effect has also been demonstrated in the case of glucose oxidase, decreasing the thermal inactivation rate by up to 50% at temperatures between 50° C. and 70° C. The addition of high concentration of trehalose greatly improves the stability of encapsulated material. The added amount of trehalose may be between 0.3 M and 0.9 M, or more specifically between 0.5 M and 0.7 M (giving the trehalose concentration with respect to water content, for example). The protective effect of trehalose against dehydration, heat and storage was demonstrated in the example of glucose-sensitive agarose films involving a cascade reaction between glucose oxidase (GOx) and horseradish peroxidase (HRP), using 3,3′,5,5′-tetramethylbenzidine (TMB) as an HRP substrate. Trehalose-containing formulations showed up to 80% remaining sensitivity to glucose after dehydration, no significant degradation after heat treatment for 60 min, and a remaining sensitivity of 30% after 2 months storage under vacuum at 25° C., whereas trehalose-free formulations showed less than 10% remaining sensitivity after dehydration and negligible response to glucose after heat treatment at 60° C. for 30 min.

In the following, the impact of trehalose or sucrose as an exemplary additive on film viscoelastic properties is briefly explained. The addition of trehalose significantly impacts the thermomechanical properties of the agarose layer. The presence of non-gelling polysaccharide (i.e., trehalose) in agarose gels, even in minute amount (below 0.5% w/w), has been shown responsible for a reduction in drying and shrinkage kinetics due to the water-binding role of the additive. At higher concentrations (20-60% w/w), sucrose, which is often used as a replacement for trehalose, increased the gelation temperatures, with a gradual transition from a brittle and coarse network (large pores) to a more homogeneous fine-stranded and highly deformable gel structure (nucleation vs bundle growth, larger elastic modulus, larger strain and stress at failure). Ultra-low gelling temperature agarose can be used to counteract the effect of trehalose on the glass transition temperature Tg of the material and maintain the film processability around a temperature of 60° C.

It is next briefly explained how the chemically active fibre device 1 can be made better suitable for glucose enzymatic assays. Enzyme-based amplification of the optical signal is a popular approach for signal generation in analytical systems, such as immunoassays and biosensors. For optical detection, it typically relies on the enzyme-catalysed oxidation of a colorimetric indicator in the presence of hydrogen peroxide, which is present as an intermediate product of catalytic oxidation of certain metabolites such as glucose, lactate or ascorbic acid. In this indirect approach, HRP is often the enzyme of choice thanks to its high activity, low substrate specificity and facility of conjugation.

The agarose layer plays the dual role of improving the enzyme stability and maintaining the different active agents in closer proximity. Furthermore, the layer can accommodate a buffer formulation to ensure the consistency of the pH environment during the capillary assay, as well as positive controls in the form of glucose-loaded coatings.

It is next explained how the chemically active fibre device 1 can be used for C-reactive protein (CRP) immunoassays. A turbidimetric assay is advantageously selected to quantify the presence of CRP. Turbidimetry relies on the antigen-induced aggregation of micron-sized latex particles or beads, modifying light scattering through the solution proportionally to the antigen concentration. It is widely used thanks to its simplicity (single step) and specificity. CRP-induced agglutination requires the free diffusion of the latex beads. Encapsulation inside an agarose film would lead to an irreversible immobilisation of the large beads. Hence, a dissolvable coating based on the vitrification properties of trehalose was developed as a matrix for the latex assay. FIG. 3 illustrates the latex turbidimetry assay for CRP sensing. A fibre-based CRP assay is released from a dissolvable sugar-based coating 7 upon contact with the liquid sample. When CRP 11 is present, latex beads 13 start to agglutinate, effectively reducing light transmission through the channel 5. Rapid dissolution of the coating 7 is visible as the channel coloration becomes homogenous over its entire surface within a few minutes. Due to the faint coloration, quantification relies totally or partially on image analysis to determine CRP-induced decrease in light transmission from the respective channel image.

In the following, it is explained how the chemically active fibre device 1 can be used for protease assays. Proteases regulate many complex biological processes. In wound exudates, low levels of these protein-degrading enzymes have been found for healing acute wounds, whereas elevated levels of matrix metalloproteinase (MMPs) and human neutrophil elastase (HNE) have been consistently found in chronic wounds. Although originally required to decontaminate and debride open wound tissues, this excessive proteolytic activity results in failure of the reconstruction of the extracellular matrix necessary for re-epithelisation.

Protease activity monitoring is commonly achieved using colorimetric substrate, such as azocasein, or fluorescence-based methods involving fluorogenic peptide or heavily labelled proteins. For the matter of simplicity, in an exemplary setting, the inventors explored the use of azocasein as an inexpensive and generic substrate. Azocasein assays are usually performed in multiple steps, involving a precipitation of non-digested casein and resuspension of smaller fragments for absorbance measurement. Here, the approach can be simplified by using a plasticised azocasein film 7 placed on the side of the capillary channel 5. When in contact with trypsin as a model proteolytic enzyme, azocasein is quickly degraded, directly releasing azo dyes in the channel core. A similar approach was implemented using gelatin stained with bromophenol blue. Gelatin is also known as a generic protease substrate but appeared to degrade much slower compared to azocasein in the present configuration.

Storage conditions of the chemically active fibre device 1 (and thus also the preform) are next explained. As water is removed during drying, aqueous solutions of trehalose (and agarose) form an amorphous glass. Maintaining this “frozen” state is important to guarantee the matrix stability, as a high molecular mobility would promote protein denaturation/aggregation and sugar crystallisation. Such unfavourable effect would become apparent upon prolonged storage of trehalose-containing formulations in the fridge. Here, water uptake acts as a strong plasticiser, drastically reducing the matrix glass transition temperature Tg and ultimately allowing a transition into a rubbery state. Small molecules, such as sugar, are then able to undergo crystallisation, forming a separate phase that dissociates from the stabilised molecule and loses its protective effect. This behaviour is highlighted in spray-dried bacteriophage and enzyme formulations containing trehalose or sucrose. It was discovered that storage in vacuum at room temperature is sufficient to maintain trehalose-based matrices in a stable glassy state. It is underlined that the polymer matrix could also play a role in preventing or delaying crystallisation, as shown with maltodextrin-trehalose and agarose-gelatin-trehalose composites.

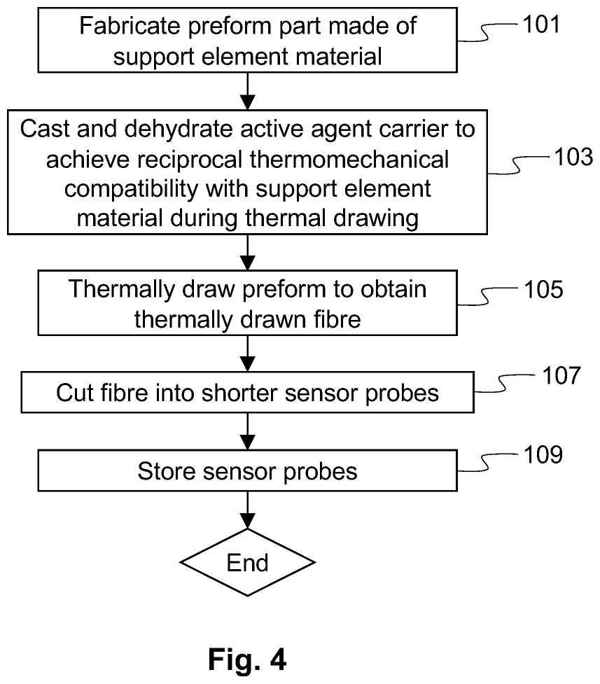

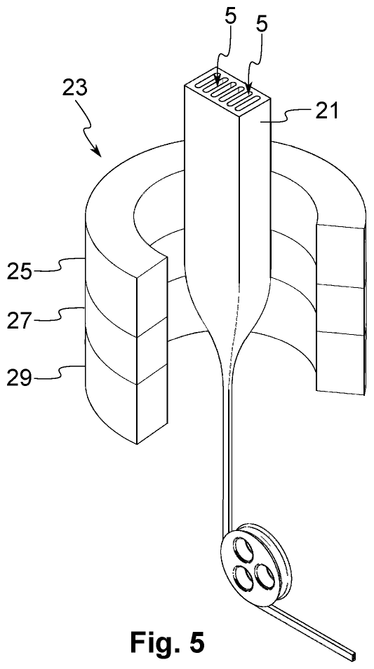

An exemplary, non-limiting fabrication or manufacturing process of the chemically active fibre device according to the present disclosure is next explained in more detail with reference to the flow chart of FIG. 4 and FIG. 5. The process starts in step 101 by making the preform 21. In this case an ethylene vinyl acetate (EVA40W, 40% by weight vinyl acetate comonomer content) is used as the support element material. It is first hot pressed, e.g., at a temperature comprised between 80° C. and 100° C. (e.g., approximately at 90° C.) for a given time duration, such as approximately 20 min under a given pressure, such as a pressure of 2.5 N/cm²×24×170 mm using a hot press and 3D printed mould to shape multiple channels. The preform can be prepared as two elongated halves to facilitate film positioning or gel casting into the channels 5. Agarose gels can be directly cast into the channels, which may have a semi-cylindrical cross section to ensure homogenous gel thinning during drying. However, it is to be noted that the shape of the cross section of the channels may have any desired shape, such as a rectangle. Casein and gelatin-based sensing layers for protease assay can be cut from plate-cast gels and inserted into the side of channels 5. Thanks to its hot-melt adhesive properties, the preform 21 can be easily sealed by briefly heating up the interface between the two halves. The channel surface hydrophilicity can be improved by hot pressing a hydrophilic film 9, such as a polyvinyl acetate (PVAc MW 100′000, solvent cast from a 10 wt % acetone solution) film on the surface to ensure rapid capillary action.

In step 103, the active agent carrier in a liquid state is cast directly into the preform channels 5 or into a separate mould, and in this example dehydrated for 12 h at 37° C. inside a convection oven. The aim of this step is to achieve reciprocal thermomechanical compatibility with the support material during thermal drawing. In step 105, the preform is thermally drawn in a draw tower 23 comprising a furnace. In this example, the draw tower 23 is a three-zone draw tower, where each zone is configured to have an independent temperature setting. The first or top zone 25 is set to a first temperature T1, the second or middle zone 27 is set to a second temperature T2 and a third or bottom zone 29 is set to a third temperature T3. In this case the second temperature T2 is greater than the first temperature T1, which in turn may be greater than the third temperature T3, such that the second temperature T2 may be a value comprised between 55° C. and 70° C., the first temperature T1 may be a value comprised between 25° C. and 35° C., and the third temperature T3 may be a value comprised between 20° C. and 30° C. (i.e., it equals or substantially equals the ambient or room temperature). In this specific example the temperature values are approximately 30° C., 60° C. and 25° C. for the top zone, middle zone, and bottom zone, respectively. The preform is fed into the furnace at a speed between 0.5 mm/min and 1 mm/min, although a lower or higher speed may be used instead. In this example, the preform 21 is fed into the furnace from the top so that it passes through the furnace by gravity, i.e., under its own weight, and produces a lower end, which is the end first exiting the furnace. The preform 21 may be provided with one or more small weights to initialise the drawing process. The fibre drawing speed is varied between 0.05 m/min and 0.1 m/min to result in a 10× draw-down ratio. The draw-down ratio is a measure of the reduction in size of a drawn product from the preform to its final size. In the present example, after the thermal drawing process, the fibre has a cross-sectional area orthogonally to its longitudinal axis comprised between 1 mm² and 20 mm².

In this configuration, the preform went through a maximum temperature of 60° C. for approximately 30 min. After drawing, in step 107 the fibre is cut into shorter portions of a given length to obtain the final chemically active fibre device 1. The length may be a value comprised between 0.5 cm and 10 cm, 1 cm and 5 cm, or more specifically between 1 cm and 3 cm. In this specific example, the length is 2 cm or substantially 2 cm. In step 109, the probes 1 are stored in vacuum, for example at 25° C. (or ambient or room temperature) until use. The fabrication process may optionally also comprise the step of adding one or more coatings or material layers comprising one or more chemically active materials or substances after the thermal drawing process on the thermally drawn fibre and/or within one or more hollow channels 5 comprised in the preform 21.

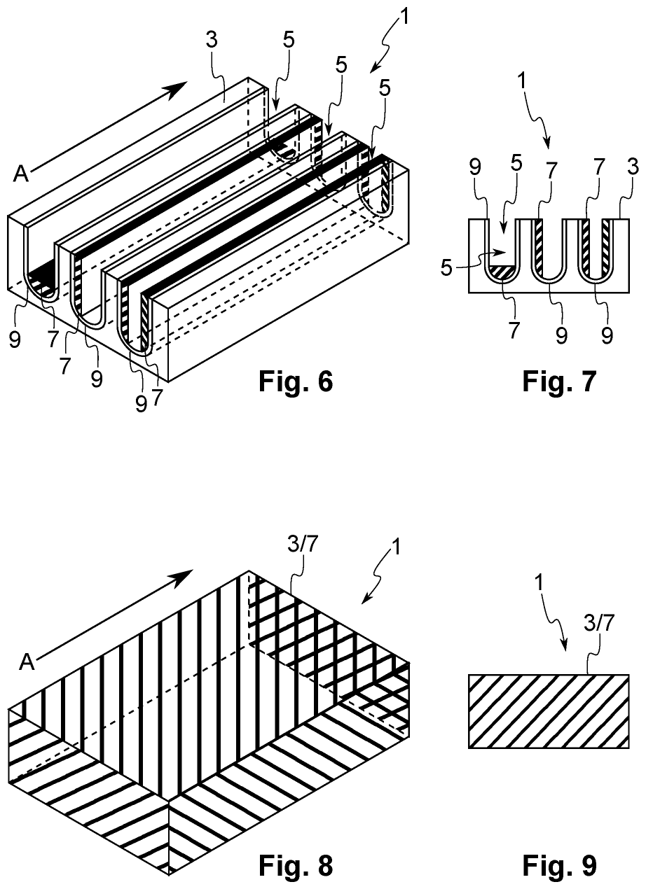

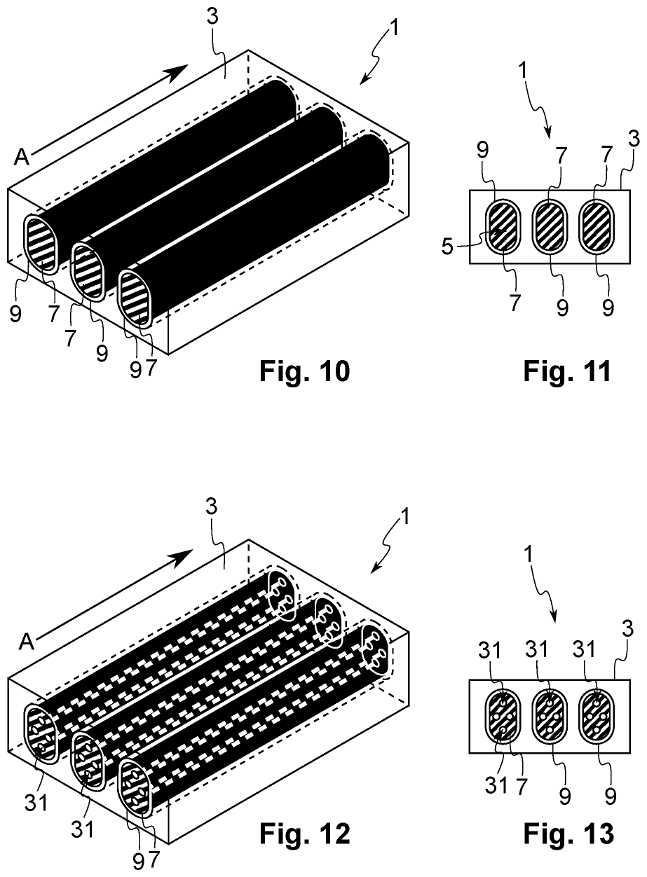

FIGS. 6 to 13 show some variants of the chemically active fibre device 1. FIGS. 6 and 7 illustrate the second embodiment of the chemically active fibre device. The main difference compared with the first chemically active fibre device of the first embodiment is that according to the second embodiment, the channels are open to the outside along their longitudinal axis, i.e., they are not closed channels. Thus, the agent carrier 7 is exposed to the outside, in other words to the air and/or the liquid to be sensed. According to the third embodiment shown in FIGS. 8 and 9, the active agent is embedded in the support element, which may be understood to form the agent carrier 7, as well as being at the same time the support element 3. In this case, the support element 3 may be a porous element. FIGS. 10 and 11 illustrate the fourth embodiment of the present invention, where the agent carrier occupies the entire or substantially entire channel 5. According to this embodiment, the agent carrier is also a porous element. FIGS. 12 and 13 illustrate the chemically active fibre device 1 according to the fifth embodiment, which is similar to the chemically active fibre device according to the fourth embodiment but with the difference that the agent carrier 7 comprises one or more channels 31 (agent carrier channels or second channels) extending longitudinally in the agent carrier, in this case longitudinally through the agent carrier 7. When in use, the liquid to be sensed thus enters these channels thanks to the capillary effect to come in contact with the active agents.

According to the present invention, a new approach was reported above for the fabrication of microanalytical devices, which optionally take advantage of the capillary effect. The proposed approach relies on the thermal drawing of low processing temperature polymer (as the support element) combined with a specific encapsulation matrix that enhances the stability of bioactive or sensitive molecules (i.e., the active agents) while providing thermomechanical properties compatible with the support element material during thermal drawing. The inner channel walls of the channels 5 are functionalised in a controlled and simple manner for instance in the form of sensitive coatings loaded with various active agents. After cutting, the drawn devices can be directly used as “out-of-the-box” test strips, allowing for several single-step biochemical assays to be performed in parallel inside a single test probe. The proposed multi-material fibre capillaries thus offer a novel platform to perform rapid fluid sampling and analysis. Above, the fluid samples were explained to be liquid samples, but they could instead or in addition be for example gas samples. This approach opens up new opportunities for designing advanced chemical assays through the combination of different materials at the micro-scale, while avoiding the typical complexity of post-modification steps. These novel lab-in-fibre biosensors possess the desirable features (integration, small size, low cost, ease-of-use) that make them highly suitable for in situ or remote analysis, potentially competing with lab-on-chip devices in a wide range of point-of-care applications or environmental monitoring. Furthermore, it is also amenable to exploit other chemical sensing strategies commonly used in biomedical assay, such as fluorescence and (electro)chemiluminescence. As a proof-of-concept, colorimetric assays were demonstrated for pH, glucose, CRP, and proteases, which are acknowledged biomarkers of the wound healing status.

While the invention has been illustrated and described in detail in the drawings and foregoing description, such illustration and description are to be considered illustrative or exemplary and not restrictive, the invention being not limited to the disclosed embodiments. Other embodiments and variants are understood, and can be achieved by those skilled in the art when carrying out the claimed invention, based on a study of the drawings, the disclosure and the appended claims. Further embodiments may be obtained by combining any of the teachings above.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A method of fabricating a chemically active fibre device by thermal drawing, the method comprising the steps of:
providing a preform, the preform comprising a support element at least partially made of a first polymeric material; and
carrying out a thermal drawing process of the preform to produce a thermally drawn fibre,
wherein the preform comprises one or more chemically active agents and/or biological materials configured to react with a fluid sample when the one or more chemically active agents and/or biological materials are in contact with the fluid sample, and wherein the one or more chemically active agents and/or biological materials remain active after the thermal drawing process.

2. The method according to claim 1, wherein the preform comprises one or more agent carriers comprising the one or more chemically active agents and/or biological materials.

3. The method according to claim 2, wherein the one or more agent carriers are at least partially made of a second polymeric material.

4. The method according to claim 2, wherein the one or more agent carriers are made of a porous material having pore diameters between 2 nm and 500 nm, and/or the one or more agent carriers comprise one or more channels for receiving the fluid sample.

5. The method according to claim 2, wherein the one or more agent carriers are made of a material dissolvable in the fluid sample, and wherein the fluid sample is a liquid sample.

6. The method according to claim 2, wherein the one or more agent carriers are at least partially made of a gel-like material, a dehydrated material or a partially dehydrated material.

7. The method according to claim 6, wherein the gel-like material is a polymerised gel, a physical hydrogel or an excipient formulation.

8. The method according to claim 6, wherein the gel-like material is selected from a non-limiting list comprising chitosan, alginate, agarose, gelatin, elastin, collagen, agar/agarose, fibrin, proteoglycans, a polyamino-acid or its derivatives, preferably polylysin or gelatin methyl cellulose, carbomethyl cellulose, polysaccharides and their derivatives, preferably glycosaminoglycanes, such as hyaluronic acid, chondroitinsulfate, dermatansulfate, heparansulfate, heparine, keratansulfate, polylipides, fatty acids starch, poly(ethylene glycol), polymerisable hydrogels, such as acrylamide, as well as any derivative thereof, a fragment or fragments thereof, and any combination thereof.

9. The method according to claim 2, wherein the one or more agent carriers comprise trehalose.

10. The method according to claim 2, wherein the one or more agent carriers comprise a plasticiser and/or an excipient.

11. The method according to claim 10, wherein the plasticiser or excipient is selected from a non-limiting list comprising a mono- di- and/or oligosaccharide, polyols, including glycerol, sorbitol, glucose, sucrose, maltitol, xylitol, erythritol, or isomalt, trehalose, cyclodextrin, maltose, lactose, sorbitol, dimethyl sulfoxide, propylene glycol, ethylene glycol and polyethylene glycol.

12. The method according to claim 1, wherein the support element comprises one or more channels for receiving the fluid sample, and wherein the one or more agent carriers is/are placed within the respective channel, and/or the one or more agent carriers form a coating for the respective channel.

13. The method according to claim 12, wherein the preform further comprises one or more hydrophilic layers at least partially encompassing the one or more channels, and having a static contact angle comprised between 5° and 80°.

14. The method according to claim 13, wherein the one or more hydrophilic layers are at least partially made of a material selected from a non-limiting list selected from poly(ethylene glycol), polyvinyl acetate, polyvinyl alcohol and polycaprolactone.

15. The method according to claim 1, wherein the active agent is selected from a non-limiting list comprising a growth factor, a protein, a peptide, an enzyme, an antibody or any derivative thereof, an antigen, any type of nucleic acid, such as deoxyribonucleic acid, ribonucleic acid, small interfering ribonucleic acid or micro(ribonucleic acid), a hormone, an anti-inflammatory agent, an anti-viral agent, an anti-bacterial agent, a cytokine, a transmembrane receptor, a protein receptor, a serum protein, an adhesion molecule, a lipid molecule, a neurotransmitter, a morphogenetic protein, a differentiation factor, an analgesic, pharmacologically active organic molecules including drugs, such as antibiotics or chemotherapeutics, pH indicator organic molecules, a cell matrix protein, a vitamin, a pesticide, a spore, a cell, a microorganism including bacteria, fungi and viruses, and any functional fragment or derivative of the foregoing, as well as any combinations thereof.

16. The method according to claim 1, wherein the first polymeric material and/or the second polymeric material has/have a glass transition temperature comprised between −60° C. and 60° C.

17. The method according to claim 1, wherein the first polymeric material is selected from a non-limiting list comprising ethylene vinyl acetate, polyvinyl chloride, one or more ionomers, polycaprolactone, glycol-modified polyethylene terephthalate, poly(lactic-co-glycolic acid), one or more polyolefin elastomers, amorphous poly(lactic acid), and gelatin.

18. The method according to claim 1, wherein the drawing process is carried out at a temperature comprised between 50° C. and 70° C., or more specifically between most 55° C. and 65° C.

19. The method according to claim 1, wherein the first polymeric material has a density comprised between 0.85 g/cm³ and 1.4 g/cm³.

20. The method according to claim 1, wherein the fibre has a cross-sectional area orthogonally to its longitudinal axis comprised between 1 mm² and 20 mm².

21. The method according to claim 1, wherein the preform comprises one or more additional materials, wherein the one or more additional materials are for example electrically conductive materials, stretchable polymers and/or semiconductors.

22. The method according to claim 1, wherein the method further comprises adding one or more coatings comprising one or more active materials after the thermal drawing process on the thermally drawn fibre and/or within one or more channels comprised in the preform.

23. The method according to claim 1, wherein the method further comprises cutting the thermally drawn fibre into a plurality of chemically active fibre devices.

24. The method according to claim 23, wherein the chemically active fibre devices have a length between 0.5 cm and 10 cm, and more specifically between 1 cm and 5 cm.

25. The method according to claim 1, wherein the method further comprises drying an active agent carrier comprised in the support element before the thermal drawing process to make the thermomechanical properties of the plurality of materials of the preform compatible with that of the support element material during the thermal drawing process.

26. A thermally drawn chemically active fibre device for sensing a fluid sample, the chemically active fibre device comprising: a thermally drawable support element at least partially made of a first polymeric material; and one or more chemically active agents and/or biological materials configured to react with the fluid sample when the one or more biochemically active agents and/or biological materials are in contact with the fluid sample at least after the support element and the one or more chemically active agents and/or biological materials have undergone a thermal drawing process.

27. The chemically active fibre device according to claim 26, wherein the support element is made of transparent or translucent polymeric material.

28. The chemically active fibre device according to claim 26, wherein the support element comprises one or more channels extending through the support element along a longitudinal axis of the support element.
